(19) United States
(12) Patent Application Publication
(10) Pub. No.: US 2004/0061788 A1
(43) Pub. Date: Apr. 1, 2004

(54) Multiple mode capture button for a digital camera

(75) Inventor: John Bateman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/256,766

(22) Filed: Sep. 26, 2002

(51) Int. Cl. H04N 5/225

(52) U.S. Cl. 348/220.1

(57) ABSTRACT

A system and method for capturing both still images and video using a single user input element. The user input element functions both (1) as a mode selection input, and (2) as a capture input. The user input element could be a button, switch, dial or other input element. In one embodiment, the digital camera is equipped with a dual-mode capture button, which combines a slider button with a transparent capture button. The transparent capture button actually has two distinct contact points on the printed circuit board. One contact point corresponds to the still camera icon, and thus to capture of still image data, while the other contact point corresponds to the video camera icon, and thus to the capture of video data. Sliding the transparent button in one direction uncovers a still camera icon, while sliding the button in another direction uncovers a video camera icon. When the button is positioned over one of the icons, the other icon is obscured. When pressed, the capture button makes contact with one of two contact points on the printed circuit board.

### BACKGROUND OF THE INVENTION

1. Field of the Invention

This invention relates generally to digital cameras for capturing still images and video, and more particularly, to the data capture button for such devices.

2. Description of the Related Art

Digital cameras are increasingly being used by consumers to capture both still image and video data.

Previously, certain digital cameras were available for capturing still image data, while other digital cameras were available for capturing video data. Recently, dual-mode digital cameras have become available. Such dual-mode digital cameras can capture both still image data and video data. However, still image data and video data may be treated differently by the camera. For instance, still image data may be compressed using Joint Photographic Experts Group (JPEG) algorithms, while video data may be compressed using Moving Pictures Experts Group (MPEG) algorithms.

Since the same camera is now used to capture both still image and video data, the digital camera needs to be instructed regarding whether the user desires to capture still images or video data. Thus the digital camera needs to have two different “capture modes” one for still image data, and one for video data. When the camera is in the “still image capture mode,” the camera software is instructed to process the captured data as still image data. When the camera is in the “video capture mode,” the camera software is instructed to process the captured data as video data.

Currently, most dual-mode digital cameras operate in one of several ways. One way is to require the user to interact with the software of the camera (e.g., via a Liquid Crystal Display (LCD) or a Liquid Crystal Monitor (LCM) on the camera) to select which capture mode (i.e., still image or video) is to be used. A separate capture button (generally in hardware) is used to capture the data. Another way is to have a first button/switch for selecting the capture mode of the camera, and a separate capture button for capturing either still images or video data, depending on which capture mode the camera was set in by the first button. In each of these situations, the user of such digital cameras is required to associate the state of another user interface element (e.g., LCD, LCM, or physical button) with the behavior of the capture button.

There is thus a need for a digital camera where a user can capture both still pictures and video data in a simple manner. In addition, there is a need for a digital camera where the user does not need to associate the state of another user interface element with the behavior of the capture button in order to capture still image or video data.

### BRIEF SUMMARY OF THE INVENTION

The present invention is a system and method for capturing both still images and video using a single user input element. The user input element functions both (1) as a mode selection input, and (2) as a capture input. The user input element could be a button, switch, dial or other input element. A digital camera in accordance with an embodiment of the present invention is simple for a user to understand and use.

In one embodiment of the present invention, the input element on the digital camera clearly identifies to a user whether activating the capture of an image at a given time will record a still picture or a video. The input element also clearly identifies to the user that both functions are supported by the digital camera.

In one embodiment of the present invention, the digital camera is equipped with a single dual-mode capture button, which combines a slider switch with a transparent capture button. The transparent capture button actually has two distinct contact points on the printed circuit board. One contact point corresponds to the still camera icon, and thus to capture of still image data, while the other contact point corresponds to the video camera icon, and thus to the capture of video data. Sliding the transparent button in one direction uncovers a still camera icon, while sliding the button in another direction uncovers a video camera icon. When the button is positioned over one of the icons, the other icon is obscured. When the button is positioned so that one of the icons is uncovered, the capture button can be clicked. When pressed, the capture button makes contact with one of two contact points on the printed circuit board. In one embodiment of the present invention, the icons are backlit by an LED.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1A is a block diagram of a portion of a conventional digital camera with a separate capture button and mode selection button.

FIG. 1B is a diagram of an LCD display on a conventional digital camera where a user has to make software selections to select the mode of the camera.

FIG. 2A is a block diagram of a portion of a digital camera in accordance with one embodiment of the present invention.

FIG. 2B is a flowchart indicating the functioning of a digital camera in accordance with an embodiment of the present invention.

FIG. 3A illustrates one position of a capture button on a digital camera in accordance with an embodiment of the present invention.

FIG. 3B illustrates another position of a capture button on a digital camera in accordance with an embodiment of the present invention.

FIG. 4 illustrates another embodiment of the capture button.

### DETAILED DESCRIPTION OF INVENTION

The figures depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein.

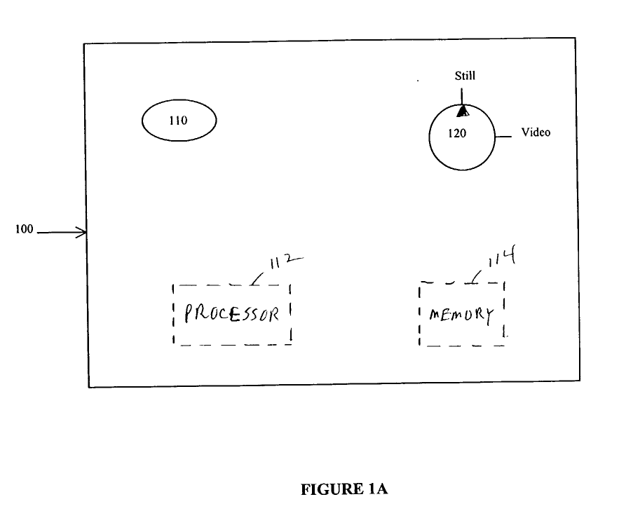

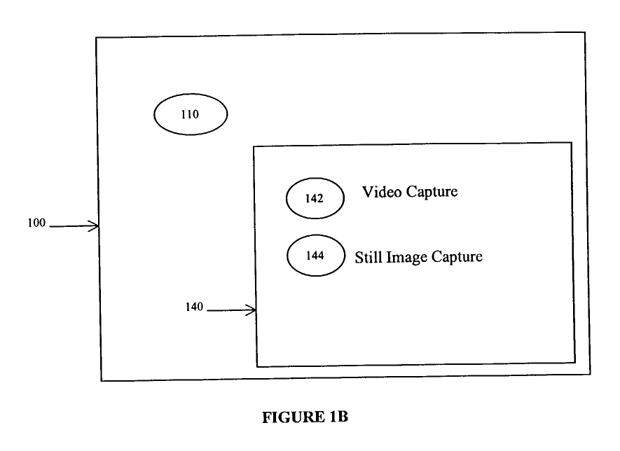

FIG. 1A is a block diagram of a portion of a conventional digital camera with a separate capture button and mode selection switch. The conventional digital camera 100 has a capture button 110 and a mode selection switch 120. A processor 112 and memory 114 are shown in phantom, interior to the camera for controlling the camera operation. The processor could be a microprocessor, or any circuit with processing capability. The memory could be a frame buffer for storing an image, or a buffer for storing part of an image while it is in the process of being transferred to a computer, or simply an image sensor.

Referring to FIG. 1A, it can be seen that when a user wishes to capture a still image, he has to first ascertain whether the mode selection switch 120 is positioned so that “Still” is selected. If not, the user needs to manipulate the mode selection switch 120 so that “Still” is selected. He then has to hit the capture button 110 in order to capture the still image. Similarly, when the user wants to capture video, he has to first ascertain whether the mode selection switch 120 is positioned so that “Video” is selected. If not, the user needs to manipulate the mode selection switch 120 so that “Video” is selected. He then has to hit the capture button 110 in order to capture the video. Thus the user needs to select (or ascertain) the state of the mode selection switch 120 before he can capture a still image or a video. That is, the user is required to be aware of both the mode selection switch 120 and the capture button 110 each time he wants to capture data with the conventional digital camera 100.

FIG. 1B is a diagram of an LCD display on a conventional digital camera where a user has to make software selections to select the mode of the camera. The conventional camera 100 has a capture button 110 and a Liquid Crystal Display (LCD) 140. The LCD 140 is shown to have two software buttons 142 and 144.

If the user of the conventional digital camera 100 wishes to capture a still image, he needs to interact with software menus on the LCD 140 to navigate to the screen containing software buttons 142 and 144 illustrated in FIG. 1B. Software buttons 142 and 144 correspond respectively to the selection of video capture mode and still image capture mode. The user then selects the software button 144 corresponding to still image mode. He then clicks on the capture button 110 to capture the still image. Similarly, when the user wishes to capture a video, he needs to interact with software menus on the LCD 140 to navigate to the screen containing software buttons 142 and 144 illustrated in FIG. 1B. The user then selects the software button 142 corresponding to video mode. He then clicks on the capture button 110 to capture the desired video. As in the system described with reference to FIG. 1A, here too, the user has to be aware of both the state of the mode selection software, as well as the capture button 110 when he wants to capture either still image or video data.

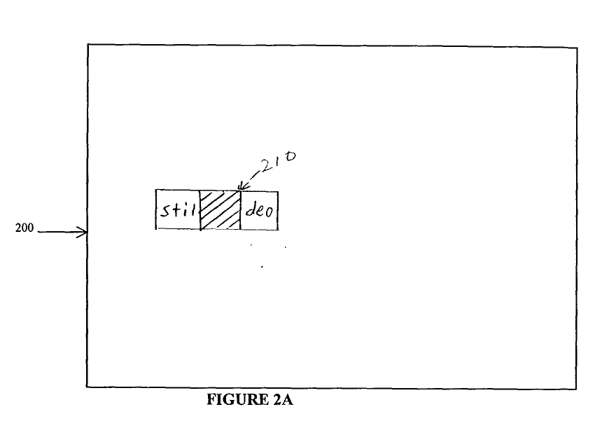

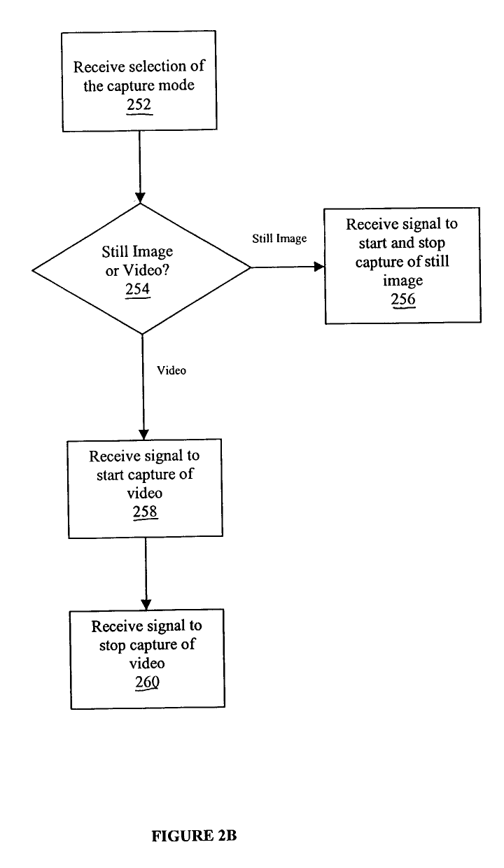

FIG. 2A illustrates a block diagram of a portion of a digital camera in accordance with one embodiment of the present invention. The digital camera 200 has a single button 210 which serves as both the capture button and the mode selection switch. By sliding left or right, it is put into the video or still mode. By pressing it, image capture is initiated.

In another embodiment, the digital camera 200 has more than two modes. For instance, instead of still image and video being the only two modes of the digital camera 200, the digital camera 200 may have three modes: still image, video and audio. That is, the digital camera 200 may also have the capability of functioning as a simple audio recorder. If so, the capture button 210 has three modes corresponding to still image, video and audio. Alternately, any combination of modes could be used, such as just two modes for still images and audio, but no video. In yet another embodiment, the capture button 210 only has a still image mode and a video mode, while audio capture alone is controlled by a separate capture button. It will be apparent to one skilled in the art that the actual number of modes which can be selected by the capture button 210 may vary.

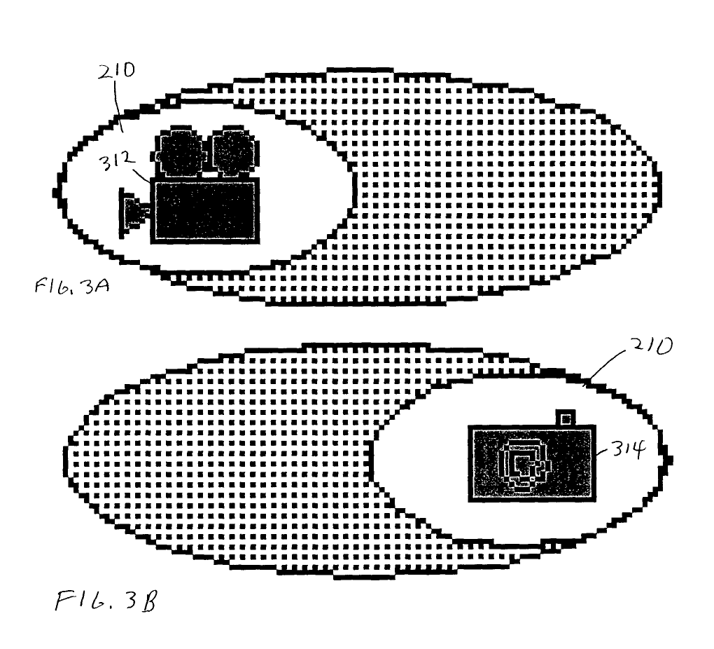

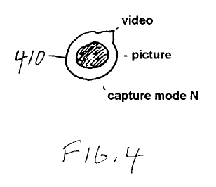

FIG. 2B is a flowchart which illustrates the steps taking place in the camera 200 in accordance with one embodiment of the present invention. As can be seen from FIG. 2B, the camera 200 receives (step 252) a selection of the capture mode of the camera. The selection of the specific capture mode to be used can be done in one of several ways. In one embodiment, the capture button 210 is a rotatable button where one position of the rotatable button corresponds to one capture mode, and a different position of the rotatable button corresponds to a different capture mode. In one embodiment of the present invention, the capture button 210 is a sliding button. In one embodiment of the present invention, the single capture button 210 combines a slider button with a transparent button. This will be described in greater detail with reference to FIGS. 3A & 3B. In one embodiment, the capture button 210 actually has two distinct contact points on the printed circuit board. One contact point corresponds to the still camera icon (thus indicating capture of still image data), while the other contact point corresponds to the video camera icon, (thus indicating capture of video data). It will be apparent to one skilled in the art that the physical character of the capture button 210 may vary.

Referring again to FIG. 2B, it can be seen that based on the above selection, the camera 200 determines 254 whether the user wishes to capture a still image of a video. If a still image is to be captured, the camera 200 receives (step 256) a signal to start and stop the capture of a still image. In one embodiment, a single press down and release of the capture button 210 by the user provides the signal to start and stop the capture of a still image.

If a video is to be captured, the camera 200 receives 258 a signal to start capture of video, and also receives (step 260) a signal to stop capture of video. In one embodiment, the capture button 210 can be pressed down and released once to provide the signal to start the capture of video. The capture button 210 can then be pressed down and released a second time to provide the signal to stop capture of video. In one embodiment, the capture button 210 can be pressed down to provide the signal to start the capture of video. The capture button 210 can then be held down while the video is being capture, and it can be released to provide the signal to stop the capture of video. It will be obvious to one of ordinary skill in the art that the signal to start capture and stop capture can be provided to the camera 200 in various different ways.

FIG. 3A illustrates one position of a partially transparent, sliding capture button 210 on a digital camera 200 in accordance with an embodiment of the present invention. The sliding capture button 210 is moved to one side to reveal a video icon 312 through the transparent portion of the capture button 210. When the button is in this position, pressing the transparent portion of the capture button 210 results in capture of video data. In another embodiment, the non-transparent portion of the capture button 210 may be pressed to capture video data in this position.

In one embodiment, this transparent portion of the capture button 210 is made of plastic. In another embodiment, the entire button 210 is made of plastic. In yet another embodiment, the transparent portion of the capture button 210 is made of glass. In yet another embodiment, the capture button 210 is not transparent. Instead, the particular mode to which a specific position of the capture button corresponds (e.g., still image, video, etc.), is written adjacent to the capture button 210. Alternatively, or in addition, the corresponding icon may be visible on the body of the camera.

FIG. 3B illustrates a second position of a partially transparent, sliding capture button 210 on a digital camera 200 in accordance with an embodiment of the present invention. The sliding capture button 210 is moved to the other side to reveal a still image icon 314 through the transparent portion of the capture button 210. When the button is in this position, pressing the transparent portion of the capture button 210 contacts the second contact point on the printed circuit board (as discussed above). This results in capture of still image data. In another embodiment, the non-transparent portion of the capture button 210 may be pressed to capture still image data in this position.

In one embodiment of the present invention, the capture button 210 can be clicked only when one of the icons 312 or 314 is uncovered. When pressed, the capture button makes contact with one of two contact points on the printed circuit board. In one embodiment of the present invention, the icons are backlit by an LED.

Another embodiment is illustrated in FIG. 4. As shown, a dial 410 can be rotated between multiple positions, each specifying a different (capture) function to be executed when the dial/button is pressed straight downwards at it's center. (capture mode N could signify capture without audio, high resolution video capture, super-compressed video capture, etc.)

Note that the capture button has at least three behaviors:

1. The button is set to the picture position; the user clicks the button; the button captures a picture.

2. The button is set to the video position; the camera is not currently capturing video. The user clicks the button and the button “begins” capturing video.

3. The button is set to the video position and the camera is currently capturing video. The user clicks the button and the button “terminates” video capture.

Alternatively to #3 above, a single click of the capture button initiates capture of video, and then video capture would automatically cease base on one of the following methods:

(a) capture ceases after a predefined time period, say 30 seconds.

(b) by use of a motion detection algorithm embedded in the camera's image processor (one embodiment of which compares pixels in successive frames of captured video and equates the number of different pixels to the amount of motion occurring in the camera's field of view.) When the motion drops below a preset level the camera automatically ceases video capture.

While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention as defined in the following claims. For example, the user input element could be a rocker switch, with user activation in one direction both selecting the mode and activating the capture at the same time. Or a dial could turn one click in a first direction to select the mode, and another click in that direction to activate the capture.

What is claimed is:

1. A digital camera, comprising:
single user input element for performing two functions,
(1) first, being activatable in a first manner to select between at least two capture modes,
(2) second, being activatable in a second manner to capture data; and
a processor coupled to the capture device to process the image data.

2. The digital camera of claim 1 wherein:
the first capture mode corresponds to capture of still image data, and
the second capture mode corresponds to capture of video data.

3. The digital camera of claim 1, wherein the user input element is a slider button.

4. The digital camera of claim 3, wherein the user input element is a transparent slider button.

5. The digital camera of claim 4 wherein the transparent slider button has a first position and a second position, the first position corresponding to the first mode and the second position corresponding to the second mode.

6. The digital camera of claim 5, wherein
a still image icon is visible when the transparent slider button is in the first position; and
a video icon is visible when the transparent slider button is in the second position.

7. The digital camera of claim 4, wherein the transparent slider button is made of plastic.

8. The digital camera of claim 1, wherein the user input element is a rotatable button.

9. The digital camera of claim 1, wherein the user input element further has a third mode, wherein the third mode corresponds to capture of audio data.

10. A digital camera, comprising:
a slider button which is activated by user pressure to capture image data, the slider button also being slidable between a first position and a second position, wherein
the first position corresponds to capture of still image data, and
the second position corresponds to capture of video data;
a processor coupled to the capture device to process the image data; and
a memory medium coupled to the processor to store the processed image data.

11. The digital camera of claim 10, wherein the slider button is transparent.

12. The digital camera of claim 11, wherein a still image icon is visible through the transparent slider button when the slider button is in the first position.

13. The digital camera of claim 11, wherein a video image icon is visible through the transparent slider button when the slider button is in the second position.

14. A method for capturing still image data and video data, the method comprising:
receiving a selection of a first mode or a second mode by detecting the position of a
user input element, wherein
the first mode corresponds to still image data, and
the second mode corresponds to video data;
in response to the selection being the first mode, receiving a signal via the capture device to start and stop capture of still image data;
in response to the selection being the second mode, receiving a signal via the capture device to start capture of video data;
processing the captured image data in accordance with the selected mode; and
storing the processed image data in memory.

15. The method of claim 14, wherein the user input element selects a mode by:
sliding the user input element to a first position to select the first mode; and
sliding the user input element to a second position to select the second mode.

16. The method of claim 14, wherein clicking said user input, while in said second mode and while video is being captured, generates a signal to stop capture of video data.
